(19) United States
(12) Patent Application Publication
(10) Pub. No.: US 2013/0248088 A1
(43) Pub. Date: Sep. 26, 2013

(54) SIZING-ADHESIVE COMPOSITION AND RELATED METHODS

(71) Applicants: Freddy Johannes Martina Andriessen, Hulst (NL); Leonard Jannusch, White Bear Lake, MN (US); Lawrence L. Micek, Woodbury, MN (US)

(72) Inventors: Freddy Johannes Martina Andriessen, Hulst (NL); Leonard Jannusch, White Bear Lake, MN (US); Lawrence L. Micek, Woodbury, MN (US)

(73) Assignee: Cargill, Incorporated, Wayzata, MN (US)

(21) Appl. No.: 13/990,600

(22) PCT Filed: Nov. 29, 2011
(86) PCT No.: PCT/US11/62402

§ 371 Date: May 30, 2013

Related U.S. Application Data
(60) Provisional application No. 61/418,157, filed on Nov. 30, 2010.

(51) Int. Cl. B29C 35/02

(52) U.S. Cl. CPC B29C 35/0277
USPC 156/182

(57) ABSTRACT

The present invention relates generally to sizing-adhesive compositions that combine a sizing component and an adhesive into one sizing-adhesive composition that strengthens the paper, resulting in less paper used and stored, and reduces costs. In one aspect, the process runs at lower temperatures, thereby reducing energy costs. Aspects of the present invention are directed to using these compositions in a process for applying the sizing-adhesive composition to optimize the bonding and sizing of papers. In one aspect, the process produces a corrugated paperboard with acceptable strength at a reduced cost. In another aspect, it provides a means of making a more sustainable packaging material by utilizing less paper, a renewable packaging material, and less energy compared to the current process used to produce corrugated board. In another aspect, the method allows for printability as the application of glue over the surface creates a flatter and more uniform surface.

### FIELD

The present invention relates generally to sizing-adhesive compositions that combine a sizing component and an adhesive into one sizing-adhesive composition that strengthens the paper, resulting in less paper used and stored, and reduces costs. In one aspect, the process runs at lower temperatures, thereby reducing energy costs. Aspects of the present invention are directed to using these compositions in a process for applying the sizing-adhesive composition to optimize the bonding and sizing of papers. In particular, it relates to novel processes to manufacture corrugated paperboard. In one aspect, the process produces a corrugated paperboard with acceptable strength at a reduced cost. In another aspect, it provides a means of making a more sustainable packaging material by utilizing less paper—a renewable packaging material—and less energy compared to the current process used to produce corrugated board. In another aspect, the method allows for printability as the application of glue over the surface creates a flatter and more uniform surface.

### BACKGROUND

The manufacturing of corrugated board typically involves the following steps:

(a) fluting a first cellulosic liner sheet by passing it between heated corrugating rolls so that the obtained “corrugating medium” has a substantially sinusoidal or serpentine cross-section;
(b) applying an adhesive to the protruding flute tips on at least one side of the corrugating medium; and
(c) bonding a non-corrugated or planar liner cellulosic sheet to the adhesive-coated flute tips.

The resulting product, having corrugating medium on one side and a liner sheet on the other, is called a “single-faced corrugated board”. It can be used, for example, as a liner or buffer material within a container. More commonly, adhesive is applied to the flute tips on both sides of the corrugating medium and a second liner sheet is applied, effectively sandwiching the corrugating medium between the two liner sheets. The resulting product is known as a “double-faced corrugated board” and is commonly used for the manufacture of cardboard boxes and other such containers or packaging materials. For increased rigidity or strength, several such single-faced and/or double faced boards can be combined to produce multiple-wall corrugated board.

To ensure proper adhesion, the step of bonding the corrugating medium to one or more liner sheets is normally carried out under pressure and utilizing pre-heater steam temperatures of about 150° C. (about 302° F.) to 200° C. (about 392° F.). These high temperatures encourage curing of the adhesive and evaporation of any excess water that may be in the adhesive liquid. However, the energy required to generate these high temperatures is expensive to maintain and can lead to overheating of the papers used to make the corrugated board, thereby damaging them and weakening the resulting corrugated board.

A 1989 study at the Institute of Paper Science and Technology (High Speed Runnability and Bonding Effects of Medium and Corrugator Conditions on Board Quality—Project 2996-22 American Paper Institute May 1, 1989) showed that optimum “pin adhesion strength”—an industry standard measure of the bonding strength of the flute tips of the corrugated medium to liner sheet—are improved by keeping liner paper temperatures from 150° F. (66° C.) to 190° F. (88° C.). The IPST study showed that increasing temperatures above 150° F. (66° C.) improved bonding as long as moisture in the paper was maintained at the 6-10% range. The adhesives used were Stein Hall adhesives applied to the flute tips of the corrugating medium. Stein Hall adhesives contain a gelled carrier starch portion that is solubilized in water and an ungelled starch portion that is “carried” (i.e., dispersed) in the adhesive. The carrier starch is often referred to as “primary” starch and the ungelled starch is often referred to as the “secondary” starch. Stein Hall adhesives are the current industry standard adhesives used all over the world.

Adhesives used in the production of corrugated board are selected on the basis of several factors, including cost and the intended use of the finished corrugated product. Starch-based adhesives, such as Stein Hall adhesives, are the most commonly used because of their desirable bonding properties, ease of preparation and low cost.

Nonetheless, there is a continued drive in the industry to reduce the cost of producing corrugated board. A number of areas have been targeted in this respect including reduction of heat energy used to manufacture corrugated board. Heat energy is one of the main costs incurred in the production of corrugated board. Heating serves two purposes in the process of making corrugated boards. First, it gelatinizes the starch-based adhesives, thereby increasing the viscosity of the adhesive and the bonding between the sheets. Second, the heat serves to dry, i.e., to remove any excess water remaining on the corrugated board from the liquid adhesives. In order to reduce heating requirements, one approach has been to reduce the water content of the adhesives by increasing their dry solid content. This concept can, however, only be taken so far as adhesive viscosity, which is directly linked to dry solid content, must be strictly controlled. An adhesive that is too viscous would be difficult to apply to the flute tips and could cause clogging and flow problems on the corrugating machine. What's more, high viscosity can cause excessive transfer of adhesive to the paper (“add-on”) thereby dramatically increasing adhesive costs.

Another approach has been to reduce the overall adhesive add-on, i.e., excessive adhesive. Again, this naturally reduces the quantity of water that will need to be evaporated off the corrugated board. It will also cut raw material costs, such as the quantity of adhesive needed per square meter of board produced. Unfortunately, the amount of adhesive add-on cannot be reduced below a certain level without having a detrimental effect on bond strength and, therefore, on board quality. In all cases, the adhesive is heated by application of the heat to the liner sheet and transferring this heat from the liner sheet to the adhesive to activate the ungelled starch in the adhesive, causing it to gel and bond.

Another area that has been targeted in an attempt to cut costs has been the basis weight,—weight of the paper per unit area—used to form the corrugated board. As paper pulp becomes more expensive due to increased demand, there is a need to decrease the use of paper (i.e., liner sheets and medium) and/or the amount of paper used to make corrugated board. A common process is to add materials such as starch to strengthen papers used in corrugated board. This strengthening is known as “sizing”. Sizing is important to increase the ability of corrugated boards used to make corrugated containers to resist collapsing when they are stacked on each other when filled with goods. This important property is known in the industry as “stacking strength”.

In order to meet multiple customer needs, the corrugated board manufacturer needs to buy papers with certain strengths and must inventory multiple papers. If the strength of the paper could be adjusted by the corrugator, this would provide a more flexible process where the strength of the corrugated board could be adjusted using fewer papers and thereby reduce the inventory of multiple papers. However, any reduction in paper sheet quality will also have a negative impact on board strength and functionality. In the current processes available to manufacturers of corrugated paperboard, the possibilities of savings by reducing both paperweight and numbers of paper in the inventory are limited.

The ability to strengthen paper by the paper manufacturer is also limited by the desire of the paper manufacturers to run their equipment at relatively high speeds of greater than 1,000 meters per minute. By increasing the paper machine speed, productivity is increased, thereby improving profitability. However, according to a study, High Speed Surface Sizing of Lightweight CCM with High Solids Starch Pastes, published in the journal Professional Papermaking, vol. 6, Glittenberg et. al., they found that penetration of these starch solutions and the resulting sizing effectiveness is limited due to the very short residence times that the sizing solutions has in the nip of the size press. In other words, if very high paper web speeds are used by paper manufacturers, less efficient sizing takes place. Corrugator speeds (i.e., paper web speeds) on the other hand are much slower than paper machines, typically well below 500 meters/min, and more often in the range of 150 to 300 meters/min. These slower corrugator speeds improve the chances for penetration of the starch solution into the paper. Thus if the sizing for the paper and the adhesive to bond the paper could be combined in one product—a sizing-adhesive—corrugators would be able to reduce paper inventories, reduce paper use, and reduce costs while operating at lower paper web speeds to enable effective sizing of the paper.

Corrugated board manufacturer must be able to run their corrugating equipment at commercial speeds in order to operate under economical conditions. This means the process must be able to rapidly bond the product. At the same time, a process that efficiently uses energy would be very desirable as often manufacturers are limited in how much heat they can supply to the process to dry water. The IPST study cited above showed that the accepted understanding of using adhesives in the industry that contain ungelled starch—known generally as Stein Hall adhesive—provide better paper bonding at higher temperatures. In fact, many corrugators will often heat liner sheets even higher than those recommended by the IPST study in the belief that more heat will more efficiently activate the ungelled starch in their adhesives creating a better bond. This is in conflict with the desire to lower temperatures and reduce energy costs.

Control of the degree of gelatinization influences the degree of tack that starch-based adhesives have as shown below. According to the Food Properties Handbook, Shaman describes the gelatinization of starch in the presence of water and heat as an endothermic reaction. On page 309, (see http://books.google.com/books?id=F9FoNy06qvcC&pg=PA294&1pg=PA294&dq=starch+gelatinization+temperature,+endothermic&source=b1&ots=WXAEg3Ifao&sig=AL21oKQ5tG81FgF-kdQGpKJ9xog&h1=en&ei=crFrTKdSxN-WB5L-5bcB&sa=X&oi=book_result&ct=result&resnum=5&ved=0CCEQ6AEwBA#v=onepage&q=star ch%20gelatinization%20temperature%2C%20endothermic&f=false) the relationship of the degree of gelatinization of the starch is generally related to the heat absorption of suspended starch and partially gelled starch in water by the equation:

α(t)=1−[Q(t)/Qₛᵤₛ] (6)

where α(t) is the degree of gelatinization and Q(t) is the heat uptake of the partially gelatinized starch and Qₛᵤₛ is the heat uptake of suspended starch. According to Rolando in Solvent-Free Adhesives, pg. 15, (see http://books.google.com/books?id=f7B7rsF3jOYC&pg=PA15&1pg=PA15&dq=starch+adhesive+tack,+gelatinization&source=b1&ots=Ch5rCSQW73&sig=rgko8ext8Hj2sFv_nK9OnjZu8oU&h1=en&ei=zdvNTMuRII3HnAegpIzkDw&sa=X&oi=book_result&ct=result&resnum=3&ved=0C BMQ6AEwAg#v=onepage&q&f=false), upon heating, “raw starch gelatinizes forming a high tack bond.” Thus control of the degree of gelatinization influences the degree of tack that starch-based adhesives have. These properties of starch gelatinization being influenced by heat uptake and tack being influenced by gelatinization provides the opportunity to regulate the temperature of the adhesive while creating tack in the adhesive. By varying the amount of secondary starch in the adhesive, not only can the degree of heat absorption in the adhesive be controlled but also the tack of the adhesive. In addition, if the adhesive is continuously applied on any of the liner sheets used in the corrugating process, greater control of the temperature of the liner sheets is also possible. This control of heat input into the liner sheets provides an advantageous way to prevent overheating of the liner sheets and causing damage to the liner sheets while imparting tack to the adhesive. Lastly, by applying a continuous layer of adhesive, paper moisture can be maintained throughout the sheet. This will result in less warp and shrinkage of the paper when it is heated. Control of paper dimensions and corrugated board flatness is important for providing a corrugated board sheet that has better printability. Better printability results in enhanced graphics and is especially important as manufacturers who use corrugated boxes to package their goods desire enhanced graphics on their packaging.

There is therefore a clear need to develop new and improved corrugating adhesives. There also exists a need for better, more economic processes for producing corrugated board which do not have a detrimental effect on the quality of the final product and improve the strength of the liner sheets while creating lower, more controllable liner sheet temperatures. These lower temperatures will result in less energy being used by the corrugators.

The present invention addresses these needs.

### SUMMARY

One aspect of the present invention includes a process for making a corrugated board comprising the steps of providing a sizing-adhesive, at least one sheet of a corrugating medium having flute tips, and at least one liner sheet, where the sizing-adhesive comprises a starch, further comprising an ungelled starch; applying the sizing-adhesive as a continuous film to at least one surface of the corrugating medium, liner sheet, or flute tips or combinations thereof, to yield a sizing-adhesive surface; heating the sizing-adhesive surface to a temperature sufficient to partially or completely gel the ungelled starch; and bonding the sizing-adhesive surface to a second corrugating medium, liner sheet, or flute tip to yield a corrugated board.

In another aspect, the amount of ungelled starch is greater than 10% and less than 80% of the sizing-adhesive solids and in another embodiment a range of greater than 30% and less than 80% and yet another embodiment a range of 50% and less than 80%. In yet another aspect, the sizing-adhesive surface is heated by direct contact with a hot surface. The sizing-adhesive surface can be heated to a temperature from about 35° C. to about 100° C. and in another embodiment a range from about 45° C. to about 100° C. In one embodiment, the process further includes cooling the temperature of the sizing-adhesive surface to less than 80° C. before bonding to a second surface. In another embodiment, the sizing-adhesive surface is cooled to a temperature of less than 70° C. In yet another embodiment, the sizing-adhesive surface is cooled to a temperature of less than 60° C.

In one aspect, the process further includes using a paper web speed of less than 1,000 meters per minute. The process further includes where the water from the sizing-adhesive is vaporized between a heating surface and the sizing-adhesive surface. In another aspect, the process further includes drying the resulting corrugated board.

One aspect of the present invention further includes a sizing-adhesive made from any of the processes described above where the sizing-adhesive further comprises one or more additives selected from the group consisting of fillers, bonding additives, humectants, tackifiers, water resistance resins, thickeners, anti-foam agents, preservatives, anti-microbials, or combinations thereof. The sizing-adhesive further comprises between about 0.1% and 30% by weight of the one or more additives on a dry weight basis. The sizing-adhesive can further comprise having a pH of about 7 or above. In yet another embodiment, at least one liner sheet is coated with the sizing-adhesive in an amount of up to 20 g/m² on a dry weight basis.

In another embodiment, a method of reducing the required weight of sheets used in the manufacture of corrugated board comprises applying the sheets with a sizing-adhesive to any of the processes described above. In a further embodiment, the required weight of the sheets can be reduced by up to 15 g/m², preferably between about 1 g/m² to about 15 g/m², more preferably between about 2 g/m² to about 8 g/m² per gram of sizing-adhesive add-on. In yet another embodiment, a method of improving the strength of the one or more sheets used in the corrugated medium comprises increasing the ECT of the corrugated board by at least 1% higher, preferably at least 5% higher, according to any of the processes described above.

Another aspect of the present invention, includes a process for producing corrugated board comprising the steps of providing at least one sheet of corrugating medium and at least one liner sheet; coating the liner sheet and/or corrugating medium on at least one surfaces with a sizing-adhesive comprising ungelled starch; heating the sizing adhesive to gel all or part of the secondary starch such that the sizing adhesive forms a tacky, bondable surface contacting the corrugating medium and liner sheet to cause adhesion at manufacturing speeds that are sufficient to make corrugated board economically.

According to an aspect of the present invention, there is provided a process where the strength of the paper is increased while manufacturing the corrugated board at commercial speeds using temperatures that are lower than suggested by the IPST study discussed above. This process utilizes a sizing-adhesive that contains ungelled starch in a range of 1-99%, preferable 20-90% and more preferably in the range of 40-80% of the sizing-adhesive on a dry weight basis that is gelled efficiently via direct contact to a pre-heater, thus transferring energy efficiently to the sizing-adhesive and paper.

According to another aspect of the present invention, there is provided a corrugated board which comprises at least one sheet of corrugating medium bonded to at least one liner sheet, characterized in that one or more of the sheets of corrugating medium and/or one or more of the liner sheets are coated with a sizing-adhesive; and/or at least one sheet of corrugating medium is bonded to at least one liner sheet with the sizing-adhesive.

### BRIEF DESCRIPTION OF THE DRAWINGS

FIG. 1 is a graph of a ring crush test (RCT) versus paper weight basis.

FIG. 2 is graph of the Brabender viscosity as measured in Brabender Units (BU), versus temperature in degrees Celsius. The dark, dashed line with the arrow indicates the generalized cooling curve. The remaining lines indicate the results for a variety of sizing-adhesive samples tested corresponding to Table 1 further in the Detailed Description below. Specifically, they correlate to samples 036A12, 036A10, 036A17, 036A16, 036A13 and 036A9

FIG. 3 is a schematic of a process for pre-heating a single facer liner after the liner applicator. The solid line with arrows indicates wrap 1 for the liner sheet, which can go through the entire process including through the second single facing pre-heater (P2). The dashed line with arrows indicates wrap 2 for the liner sheet, which can bypass the second single facing pre-heater (P2). Number 1 in the schematic refers to a liner sheet made from a paper. Number 2 refers to a first single facer pre-heater (P1). Number 3 refers to an applicator rod on the liner applicator. Number 4 refers to an applicator roll on the liner applicator. Number 5 refers to a post metering compression nip roll. Number 6 refers to a post metering rod. Number 7 refers to an air bag. Number 8 refers to a second single face pre-heater (P2). Number 9 refers to a pressure roll. Number 10 refers to a corrugating stack. Temperature can be measured at various points, including at the medium down, single facer liner down (B), medium up, medium exit or single facer liner exit.

FIG. 4 is a schematic showing the effect of a pre-heater (A) in the lower portion of the diagram creating a water vapor pressure zone (B) between the pre-heater and the sizing-adhesive (C), which lowers the viscosity of the sizing-adhesive and pushes it deeper into the paper (D), thereby increasing its sizing effect.

### DETAILED DESCRIPTION

### Selected Definitions

As used herein, the following terms shall have the following meanings:

The term “liner sheet” as used herein refers to paper used to make corrugated board that is not fluted.

The term “corrugating medium” as used herein refers to paper used to make corrugated board that is fluted into a three-dimensional sinusoidal shape which when viewed from either side has peaks and valleys.

The term “flute tips” as used herein refers to the peaks of the corrugating medium

The term “adhesive” as used herein refers to any material used to bond the paper together in order to make corrugated board.

The term “gelled starch” or “carrier gelled starch portion” as used herein refers to starch in the adhesive or sizing-adhesive that is gelled during preparation of the adhesive or sizing-adhesive. This starch portion is sometimes referred to as the “primary” starch.

The term “ungelled starch” or “carried ungelled starch portion” as used herein refers to starch in the adhesive or sizing adhesive that is ungelled during preparation of the adhesive or sizing-adhesive. This starch portion is sometimes referred to as the “secondary” starch. The secondary starch is available for gelling during the manufacture of the corrugated board.

The term “corrugated board” as used herein refers to any sheet-type material comprising at least one sheet of corrugating medium adhered to at least one sheet of non-corrugated medium (such as a planar liner sheet). The term therefore includes single-faced boards, double-faced boards and all types of multiple-wall boards as described herein.

The term “sizing-adhesive” as used herein refers to an adhesive composition capable both of forming a bond between two sheets of paper (or cellulosic sheets) and of increasing the strength of the paper(s) to which it is applied. Specifically, it refers to those adhesives adapted for use in the production of corrugated board, as defined below.

The term “sizing-adhesive surface” as used herein refers to the surface of the liner sheet, corrugating medium, flute tip, or combinations thereof to which the sizing-adhesive is applied.

The term “sizing-adhesive solids” as used herein refers to the weight fraction of the sizing-adhesive left after drying off all of the water from the sizing-adhesive.

The term “pin adhesion strength” as used herein refers to strength of the bonding between the liner paper and the medium. The Pin Adhesion Test is standardized under TAPPI Test Method T 821 om-06. Units of measure of pin adhesion strength are commonly pounds per inch or newtons per meter.

The term “adhesive add-on” as used herein refers to the amount of adhesive that is applied to the any one or all of the papers used to make corrugated board. It is typically measured in units such as grams per meter squared (g/m²) or pounds per 1000 square feet (msf).

The term “sizing-adhesive add-on” as used herein refers to the amount of sizing-adhesive that is applied to the any one or all of the papers used to make corrugated board. It is typically measured in units such as grams per meter squared (g/m²) or pounds per 1000 square feet (msf).

The term “stacking strength” as used herein refers to the ability of the box to resist being crushed when filled with merchandise and then stacked during storage or shipping of the merchandise.

The term “applying” as used herein refers to the sizing-adhesive application method used in accordance with the present invention as differentiated from the standard flute-tip application method typically used in the corrugating industry. It refers to using one or more liner sheets and/or one or more sheets of corrugating medium that are covered over at least a portion and in one aspect substantially their entire surface, on at least one side, with the sizing-adhesive of the invention.

The term “bonding” as used herein refers to contacting together any combination of the liner and/or medium papers to which adhesive or sizing adhesive has been applied to adhere these papers in order to form a corrugated board.

The present invention provides a process wherein the temperature of the sizing-adhesive containing ungelled starch is controlled to gel part or all of the starch in the adhesive just prior to bringing the liner sheet in contact with the corrugating medium. The temperature of the liner sheet to which the sizing-adhesive is applied and the surface of the sizing-adhesive is typically less than 80° C.

### Sizing-Adhesive

The term sizing-adhesive as used herein may refer both to the liquid adhesives in their finished, ready-to-use form and to the dry or liquid pre-mixes used to prepare the finished adhesives. Sizing-adhesive dry mixes are compositions which contain water soluble polymers but none of the sizing-adhesive's final water content (as defined below). Similarly, a liquid sizing-adhesive pre-mix will contain at least one water soluble polymer and all or a part of the sizing-adhesive's final water content.

The sizing-adhesive of the present invention comprises at least one ungelled starch. The ungelled starch will be selected from native or modified starches. Native starches can be from any available source including for instance potato, maize, wheat, rice, tapioca, pea, sorghum and sago. They may be waxy or non-waxy starches. Modified starches are native starches which have been modified e.g. by enzymatic, chemical and/or heat treatment and include, by way of example, oxidized starches, acid-thinned starches, esterified starches, etherified starches, dextrins, maltodextrins, cross-linked starches and combinations thereof.

The sizing-adhesive may also contain one or more additives, selected from the group consisting of fillers such as calcium carbonate, kaolin clay or titanium dioxide; bonding additives such as polyvinyl acetate, polyvinyl acetate-ethylene or acrylic, polymers; humectants such as glycerol, glycerine or urea; tackifiers such as sodium borate or sodium metaborate; water-resistance resins such as urea-formaldehyde resins, phenol-formaldehyde resins or ketone-formaldehyde resins; thickeners such as carboxymethyl cellulose, xanthan gum or guar gum; antifoam agents; preservatives; anti-microbials and combinations thereof. Fillers may preferably be included in an amount of between 1 and 30%, more preferably between 5 and 30%, most preferably between 10 and 20% by weight on a dry weight basis. Bonding additives may be included in an amount of between 1 and 30%, more preferably between 5 and 30% by weight on a dry weight basis. Humectants may be included in an amount of between 0.5 and 10%, more preferably between 0.5 and 5% by weight on a dry weight basis. Tackifiers may be included in an amount between 0.1 and 10%, more preferably between 0.5 and 10% by weight on a dry weight basis. Water resistance resins may be included in an amount of 0.5 to 10%, preferably in an amount of 1 to 5% by weight on a dry weight basis. Thickeners may be included in an amount of 0.1 to 5% by weight on a dry weight basis. Antifoam agents, preservatives and antimicrobials will preferably be incorporated at an effective level, typically between 0.1 and 1% by weight on a dry weight basis. Further known additives may also be included as desired or appropriate. Their nature and concentration will readily be determined by a skilled person based on standard practice in the art.

The finished sizing-adhesive, i.e., the sizing-adhesive in its ready-to-use state, will preferably have a total dry substance by weight of between 20 and 80%, more preferably of between 25 and 60%. It will advantageously have a Brookfield viscosity of between 100 and 3000 milliPascal seconds (mPas), preferably of between 400 and 2000 mPas, even more preferably of between 200-1000 mPas when measured at 25° C., 100 rpm and with a no. 3 spindle. Furthermore, the ready-to-use sizing-adhesive will preferably be alkaline. According to one particular embodiment, it will have a pH of above 7, preferably above 8, and ideally of between 9 and 12.5. If necessary, the pH of the sizing-adhesive can be adjusted by adding an appropriate amount of a base such as sodium hydroxide.

The sizing-adhesive of the present invention can be used like standard corrugating adhesives, i.e. by applying it to the flute tips of the corrugating medium, but will preferably be applied directly to the one or more liner sheets, like a coating or surface sizing composition. Alternatively, it can be applied both to the flute tips of the corrugating medium and as a substantially continuous film to the liner sheet. In a yet further embodiment, it may be applied as a substantially continuous film to the corrugating medium, with or without coating of the liner sheet and controlling the temperature of the adhesive by heating the adhesive to its gel point. Thus, the present invention also relates to a novel process for producing corrugated board, characterized in that it comprises the following steps:

providing at least one sheet of corrugating medium and at least one liner sheet;

coating at least one of the liner sheets and/or sheets of corrugating medium on at least one surface with a sizing-adhesive containing an ungelled starch;

optionally applying the sizing-adhesive to the flute tips on at least one side of at least one of the sheets of corrugating medium;

heating the sizing-adhesive to completely or partially gel the ungelled starch just prior to combining the surfaces

contacting the surfaces (i.e. the one or more surfaces to which sizing-adhesive has been applied, whether continuously, discontinuously or not at all) of the corrugating medium and/or liner sheets together to cause adhesion; and

drying the resulting corrugated board.

### Corrugated Board

The term “corrugated board” refers to any sheet-type material comprising at least one sheet of corrugating medium adhered to at least one sheet of non-corrugated medium such as a planar liner sheet. The term includes single-faced boards, double-faced boards and all types of multiple-wall boards as described above.

The corrugated boards produced according to the process of the invention may have any flute height. A flute height of 4.0-4.8 mm, for example, is referred to as an A-flute; a flute height of 2.1-3 mm is referred to as a B-flute; a flute height of 3.2-3.9 mm is referred to as a C-flute; a flute height of 1.0-1.8 mm is referred to as an E-flute; a flute height of approximately 0.75 mm is referred to as an F-flute; and a flute height of 0.5-0.55 mm is referred to as an N-flute. E-, F- and N-flutes are also referred to as micro- or nano-flutes. Of course, if the board is a multiple-wall board, each “wall” may have flutes of a different height. A typical combination is, for instance, a double-wall board comprising both B- and E-flutes.

### Application Step

The term “applying” or “application” as used herein is intended to distinguish the sizing-adhesive-application method used in accordance with the present invention from the standard flute-tip application method typically used in the corrugating industry. It refers to the fact that the one or more liner sheets and/or one or more sheets of corrugating medium will be covered over at least a portion and in one aspect substantially their entire surface, on at least one side, with the sizing-adhesive of the present invention. For corrugated board containing more than one liner sheet and/or more than one sheet of corrugating medium, in one aspect includes applying the sizing-adhesive to each of the liner sheets. Thus, for example, a double-faced board may comprise one liner sheet with the sizing-adhesive applied to it and one liner sheet without the sizing-adhesive applied to it. In one preferred embodiment, both liner sheets will have the sizing-adhesive applied to at least one side of each liner sheet.

Application of the sizing-adhesive to the one or more liner and/or corrugating medium sheets can be achieved using any available method. Examples of known application technologies include, without limitation, air knife coating, rod coating, bar coating, wire bar coating, spray coating, brush coating, cast coating, flexible blade coating, gravure coating, jet applicator coating, short dwell coating, slide hopper coating, curtain coating, flexographic coating, size-press coating, reverse roll coating and transfer roll coating (metered size press or gate roll coating). Preferably, application of the sizing-adhesive will be carried out on the corrugator. In one embodiment, the preferred method of coating the sizing-adhesive onto the paper uses a meter rod roll coater to apply a continuous film onto the paper.

Preferably, the sizing-adhesive will be applied to the at least one liner and/or corrugating medium sheets in an amount of up to 20 g per square meter on a dry weight basis, more preferably in an amount of 1 to 15 g/m², even more preferably in an amount of 3 to 10 g/m².

### Bonding Step

After application, the sizing-adhesive surface of the at least one liner sheet is brought into contact with a sheet of corrugating medium (which itself may have the sizing-adhesive applied to its flute tips) to cause bonding. This step is preferably carried out under pressure applied to the adhesive to increase penetration into the paper. In the preferred embodiment, pressure is applied by physical contact of a roll or rod with the adhesive as it is being applied to the paper or after it is applied to the paper. Surprisingly, it has been found that bonding between the corrugating medium and the liner sheet does not require heat to the same extent as with traditional corrugating adhesives of the art. Thus, according to one particular embodiment, the bonding step may be carried out at a paper temperature below 80° C. (172° F.). It has been found that by using the above process, corrugated boards which are stronger and cheaper to produce can be obtained. As such, corrugated boards obtainable according to the above process, and/or corrugated boards having at least one of their one or more liner and/or corrugating medium sheets coated with the above sizing-adhesive are also part of the present invention.

In particular, it has been found that corrugated paperboard having an ECT at least 1% higher, preferably at least 5% higher by continuously coating the sizing-adhesive on one or more of the papers used to make the corrugated paperboard, preferably heating the sizing adhesive surface directly against a hot surface and thus heating the sizing-adhesive and papers to a temperature of not more than 100° C.

What's more, the corrugated boards of the present invention can be advantageously produced with sheet materials of lesser basis weight without affecting the quality of the board itself. Accordingly, a method of reducing the required weight of sheets used in the manufacture of corrugated board comprising coating said sheets with a sizing-adhesive as defined herein will also be part of the present invention. Advantageously, the required sheet weight can be reduced by up to 15 g/m², preferably by between 1 and 15 g/m², more preferably by between 2 and 8 g/m², per gram of sizing-adhesive add-on. As a result, cellulosic sheets weighing no more than 400 g/m², preferably between 75 and 200 g/m² can be used for one or more of the at least one liner sheets and/or corrugating medium sheets of the corrugated board. Preferably, for double-faced or multiple-wall boards, all of the liner sheets and/or all of the corrugating medium sheets will be selected from paper weighing between 75 and 400 g/m². Typical corrugated board weights range from 115 to 350 g/m².

### EXAMPLES

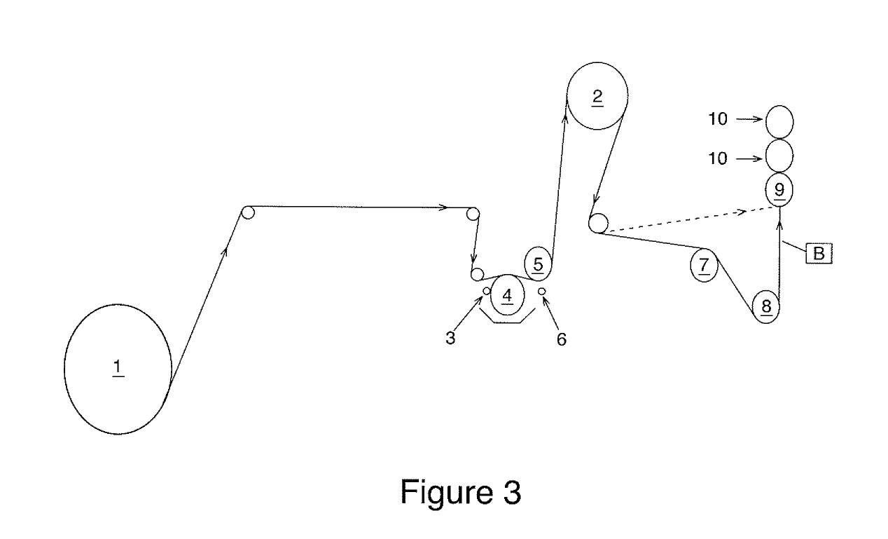

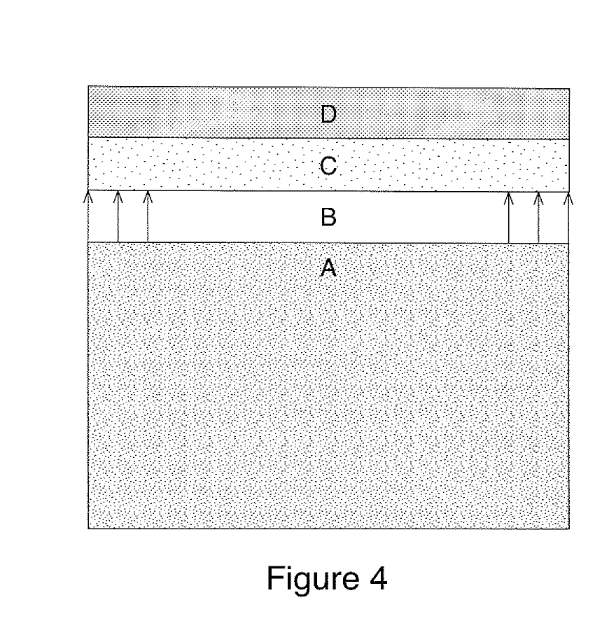

Certain embodiments of the present invention will now be described by way of the following, non-limiting examples. In one embodiment, the adhesive is applied discontinuously or preferably continuously and then passed over a steam heated metal cylinder as shown in FIG. 3. The sizing adhesive may also be heated by other means such as passing the paper coated with the sizing-adhesive through an oven, exposing the surface of the coating to infra-red heating or using a microwave or radio frequency source to heat the sizing adhesive in order to gel the secondary starch. In this embodiment, the sizing adhesive is applied continuously to the paper and then the starch in the sizing adhesive is partially or completely gelled by passing the sizing-adhesive side over the pre-heater P1 as shown in FIG. 3 and in direct contact with the pre-heater. The temperature of P1 is sufficient to vaporize the water in the sizing-adhesive. There are four significant effects resulting from this application process. The first effect is that as the secondary starch in the sizing-adhesive gels it absorbs energy as it swells lowering the temperature of the sizing-adhesive layer and the paper while the sizing-adhesive is in contact with the pre-heater and as soon as the sizing-adhesive is no longer in contact with the pre-heater P1 the secondary starch continues to gel as the paper advances past the P1 further lowering the temperature of the paper by absorbing heat. The second effect is that the paper that has passed over the pre-heater is cooled by the rapid evaporation of water from the sizing-adhesive as it contacts with the pre-heater P1 ends. The third effect is that steam is generated between the pre-heater P1 creating a pressure layer of water between the P1 pre-heater and the sizing-adhesive. At the same time, the sizing-adhesive's viscosity is lowered and this drives the sizing-adhesive deeper into the paper enhancing its sizing effect on the paper (see FIG. 4). The fourth effect is that adhesive becomes tacky due to the starch gellation and when combined with the corrugating medium, creates a bond suitable to make corrugated paperboard. The result of effects 1 and 2 is that the paper is kept at a much cooler temperature than is recommended in the IPST study cited above. These cooler temperatures minimize or even avoid damage to the paper thereby enhancing the strength of the resulting corrugated board made in this process when compared against conventionally produced corrugated board. However, due to the third effect, the sizing-adhesive is still hot enough and there is enough water in the sizing-adhesive such that the driving force of the pressure layer between the pre-heater surface combined with the lowering of the viscosity of the adhesive as it is heated, pushes the sizing-adhesive further into the paper enhancing its sizing effect.

Corrugated board manufacturers use several methods to measure box stacking strength, including the Edge Crush Test (ECT—TAPPI test no. T 838 om-07—used to measure the strength of the corrugated board itself) and the Box Compression Test (BCT—TAPPI test no. T 804 om-06—used to measure the crushing strength of a standard box made with corrugated board). In order to improve ECT and/or BCT performance it is generally accepted that higher strength papers are needed.

To understand the potential to strengthen paper, the relationship of the ECT to the paper strength is useful. The ECT's relationship to the compressive strength of the paper has been modeled generally by the Maltenfort equation:

ECT=k(σ_{C,L1}+σ_{C,L2}+α·σ_{C,Med}) (1)

### Where:

ECT=edge compression test result of the corrugated paperboard
K=a constant
σ_{C,L1}=compression strength of one of the liners—for example the single face liner
σ_{C,L2}=compression strength of one of the liners—for example the double back liner
σ_{C,Med}=compression strength of one of the medium papers
α=the take-up factor of the corrugated medium paper. This varies by flute design on the corrugating role.

The ECT test results are commonly measured in pounds per lineal inch (lbs/in) paper basis weight. For simplicity, this number is sometimes referred to as an ECT value (e.g., 42 ECT).

Other models have been developed relating the ECT to compressive strength of paper. Whitsitt's model relates ECT to RCT (Ring Crush Test) in the following way:

ECT=0.8x(RCT_{SFL}+RCT_{DBL}+αRCT_{M})+12 (2)

for paper basis weights below 42 lbs/msf, and

ECT=1.27x(RCT_{SFL}+RCT_{DBL}+αRCT_{M})−6 (3)

for paper basis weights above 42 lbs/msf,
where:
ECT—edge compression test result
RCT_{SFL}—ring crush test result of single face liner in lbs/in
RCT_{DBL}—ring crush test result of double backer liner in lbs/in
RCT_{M}—ring crush test result of medium in lbs/in
α—take-up factor of corrugated medium
See a Link Between Light-Weights and ECT, Schaepe and Popil Published at www.tappi.org.

Using data from Table 1 of Popil's article, A New Model for Converting Short Span Compression with Other Measurements to Ring Crush, a linear model of RCT vs. paper basis weight was developed with the line passing through the origin, i.e., the Y intercept was zero. The Y values of this line were the RCT (Ring Crush Test) values of papers in pounds and the X values of this liner were the basis weights of the paper from 16 to 90 lbs/msf. The resulting line had a correlation coefficient of 0.96. The derived model relates the compressive strength of the paper as measured by RCT basis weight as:

RCT=2.11×B (4)

where RCT is in lbs and B is in lbs/msf where msf equals 1000 ft².

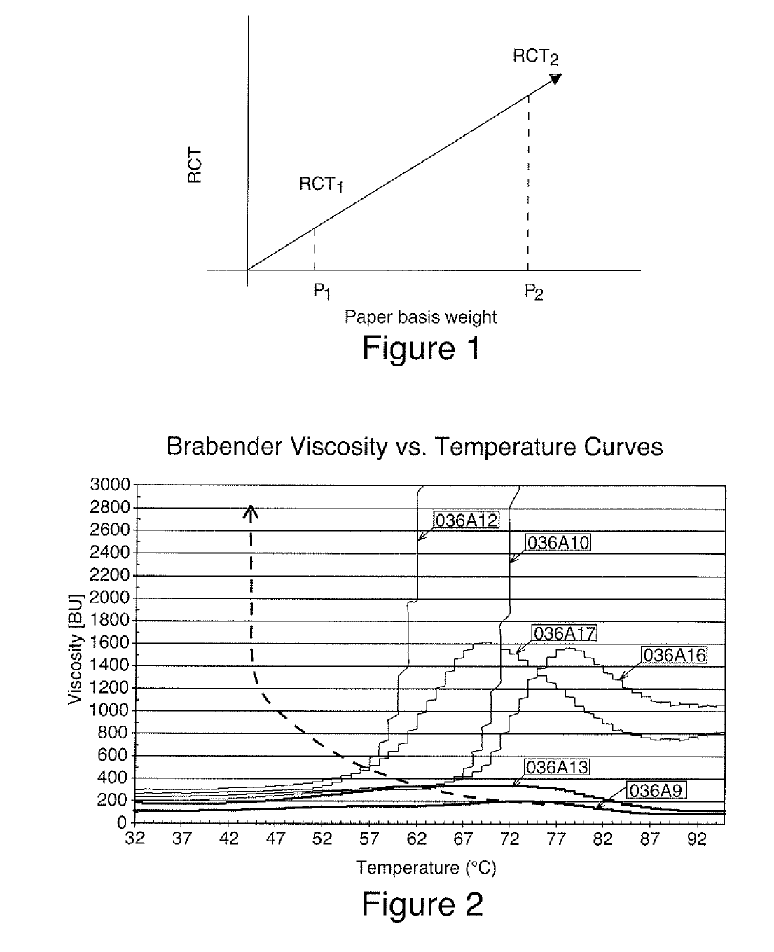

The assumption is that paper strength rises linearly as a function of basis weight if the line modeling this relationship passes through the origin, the relationship can be derived as follows. Using RCT as an indicator of increase in paper strength a line can be drawn through the origin as shown below. If this is true whenever a paper strengthening coating is applied to paper, the increase in paper strengthening should be able to be related to an equivalent increase in paper basis weight as shown in the graph in FIG. 1, where:

RCT₁=aP₁+b

RCT₂=aP₂+b

If the y-intercept is 0 as proposed in Equation (4), then:

$$a = \frac{{RCT}_{1}}{{P}_{1}} = \frac{{RCT}_{2}}{{P}_{2}} \\ {P}_{2} = \frac{{RCT}_{2}}{{RCT}_{1}} \times {P}_{1} \qquad ( 5 )$$

With this collection of relationships, it is possible to draw a conclusion on the relationship of ECT increase to paper basis weight. This will be discussed in the examples below of this invention.

All the adhesives used in the examples contain water and suspended ungelled native or ungelled modified starch. The amount of ungelled starch in these adhesives is in the range from 1-99% of the adhesive solids, preferably from 20-80% of the adhesive solids and more preferably in the range of 40-80% of the adhesive solids. All of these adhesives were successfully used to make corrugated paperboard. Table 1 shows the range of gel point temperatures for these adhesives. Gel point is the temperature at which the adhesives become a gel with a very high viscosity or even are converted to a non-flowable gel.

TABLE 1

| | | Brookfield | Brookfield |
|---|---|---|---|
| Sizing | Gel Point | Viscosity at 100 | Viscosity at 10 |
| Adhesive | Temperature (° C.) | RPMs (mPas) | RPMs (mPas) |
| C*iGlu ™ | No Gel Point | 200 | 380 |
| 036A9 | | | |
| C*iGlu ™ | 62 | 550 | 2260 |
| 036A10 | | | |
| C*iGlu ™ | 46 | 445 | 1910 |
| 036A12 | | | |
| C*iGlu ™ | No Gel Point | 340 | 980 |
| 036A13 | | | |
| C*iGlu ™ | 73 | 385 | 1130 |
| 036A16 | | | |
| C*iGlu ™ | 68 | 565 | 2650 |
| 036A17 | | | |

While not wishing to be bound theory, it is believed that the sizing-adhesive remains tacky and the temperature remains relatively stable as the degree of gelatinization remains in a range sufficient to absorb thermal energy from the pre-heater P1. There is a point, where the degree of gelatinization becomes too great—as modeled by Equation (1) above—and the heat uptake from the suspended gelled starch is maximized, pushing the degree of gelatinization out of the range where the suspended starch is still absorbing energy and the adhesive begins to become too hot. This can lead to two different modes of bond failure; cohesive and adhesive.

To illustrate the two different bond failure modes, the characteristics of the different sizing-adhesives in Table 1 will be compared. As shown in FIG. 2 generated by using a Brabender visocimeter, when the temperature of the sizing-adhesives in Table 1 is raised, the viscosities rise initially as the secondary starch is gelled. For sizing-adhesives, 036A9, 036A13, 036A16 and 036A17, viscosity drops as the temperature is increased while the starch is completely gelled and solublized. In the sizing-adhesives, 036A16 and 036A17, this initial rise of the viscosity is even more pronounced compared to 036A9 and 036A13 but also falls as their temperatures increase when the gelled starch is solubilized. In the case of 036A10 and 036A12, the viscosity vs. temperature behavior is different. The viscosity continues to climb as the temperature increases due to gels whose viscosity measurements exceed the limits of the Brabender used to generate FIG. 2. This is reflected in the viscosity increase as temperature reaches the gel point. The degree of gel formation can be generally controlled by adding varying amounts of secondary starch or by adding secondary starches that are more soluble and form less viscous gels. The 036A9 and 036A13, have much less obvious gel points when tested on a Brabender because these adhesives contain secondary starches modified such that they are more soluble as compared to the other sizing-adhesives in Table 1.

While not wishing to be bound by theory, it is proposed that the sizing-adhesives 036A9 or 036A13, if heated and maintained past a temperature where the viscosity continues to be low, will display a cohesive bond failure mode. This means that these sizing-adhesive do not have enough internal strength to maintain bonding as the papers are brought together to form the corrugated board. Sizing-adhesives such as 036A10 or 036A12, once applied to a paper and overheated display the adhesive bond failure mode. This adhesive bond failure mode is characterized by a loss of tack due to over-absorption of the water by the gelled secondary starch. Under high speed conditions, either of these bond failures are accentuated by the greater forces exerted on the paper at higher speed.

To illustrate bond conditions where these bond failures occur, sizing-adhesives 036A9 and 036A10 were used on a corrugator configured as shown in FIG. 3. Since it is important to run the corrugators as fast as possible as this improves productivity,

The peak speed of the corrugators was recorded at the point corrugated board could no longer be produced due to bond failure.

Table 2 summarizes the results.

TABLE 2

| | | | Wrap | P1 Pre- | Single | Peak |
|---|---|---|---|---|---|---|
| Test | Application | Sizing | Posi- | heater | Face Liner | Speed |
| No. | Method | Adhesive | tion | Temp | Temp. | (m/min) |
| 70 | Liner & FT | C*iGlu ™ | 1 | 172° C. | 82° C. | 46 |
| | | 036A9 | | | | |
| 324 | Liner only | C*iGlu ™ | 2 | 172° C. | 49° C. | 244 |
| | | 036A9 | | | | |
| 162 | Liner & Ft | C*iGlu ™ | 2 | 172° C. | 60° C. | 244 |
| | | 036A9 | | | | |
| 99 | Liner & FT | C*iGlu ™ | 1 | 172° C. | 82° C. | 91 |
| | | 036A10 | | | | |
| 174 | Liner only | C*iGlu ™ | 2 | 172° C. | 68° C. | 183 |
| | | C*iGlu ™ | | | | |
| | | 036A10 | | | | |
| 338 | Liner & Ft | C*iGlu ™ | 2 | 148° C. | 60° C. | 189 |
| | | 036A10 | | | | |

In column labeled “Application method”, “Liner &FT” means the sizing-adhesive was applied as a coating to the single face liner and to the flute tips of the medium paper and “Liner only” means the sizing-adhesive was applied as a coating to the single face liner paper only. The column labeled “Wrap Position” indicates the wrap used as shown in FIG. 3. The column labeled “P1 Pre-heater Temp” shows the surface temperature of the P1 pre-heater in FIG. 3. The column labeled “Single Face Liner Temperature” is the temperature measure at point B shown on FIG. 3. The “Peak Speed” is the paper web speed at to which the corrugator could be run before the single face liner paper would lose adhesion to medium paper after being combined in the corrugating stack shown in FIG. 3.

The single face liner temperature peak speed that could be reached was lower in test nos. 70 and 99. This can be explained by examining the test conditions and relating them to the viscosity vs. temperature curves shown in FIG. 2. In tests 70 and 99, the wrap position 1 shown on FIG. 3 was used. The additional heat provided by the pre-heater P2 caused different problems with both sizing-adhesives. In the case of 036A9, its viscosity was reduced, as shown in FIG. 2, and caused the adhesive to fail cohesively due to insufficient strength to hold the paper in place at higher speeds. The sizing-adhesive 036A10, gelled to the point as shown in FIG. 2 where it lost tack and didn't adhere because it became too viscous. This behavior is evidenced by the very high viscosity as the adhesive gels at higher temperatures. Even with the additional sizing-adhesive application—there was additional adhesive added to the flute tips, these sizing-adhesives, when heated using Wrap 1 as in tests 70 and 99 in Table 1 did not bond well at higher speeds. Surprisingly, the optimum bonding temperatures of these sizing-adhesives improves at lower temperatures than those indicated in the IPST study. In fact, the liner paper temperatures in tests 70 and 99 are 82° C., the upper part of the range described in the IPST study cited above (66-88° C.). Under these conditions they would be expected to work well. Instead of improving as temperature is increased beyond 66°, the bonding deteriorates as shown in samples 70 and 99 where the temperatures of the single face liner is hot enough that the sizing-adhesives are adversely affected. However, if the sizing-adhesives temperatures are kept in an optimum temperature range, their performance improves. Test nos. 324 and 338 give additional evidence that keeping single face liner temperature cooler using the same application method as test nos. 70 and 99 allows higher speeds to be used.

This behavior of the viscosity—and tack of the sizing-adhesive—is illustrated by the “Generalized Curve Curve” in FIG. 3. It is believed that the nature of the process, wherein the adhesive is heated directly against the heating vessel causes the behavior described by this curve. As these sizing-adhesives are heated against the pre conditioner, P1, there is enough water present to keep them sufficiently fluid so that as the paper passes P1, the sizing-adhesives are rapidly heated and then cooled by the combination of secondary starch gellation and water evaporation. As they cool down, the partially gelatinized starch in the sizing-adhesive creates higher tack and good bonding, provided the temperature is not increased too much. Therefore, it is desirable to keep the temperature of the adhesive in an optimum range.

Table 3 illustrates the robust nature of the temperature control in this process.

TABLE 3

| | Appli- | | Wrap | P1 Pre- | Single | Corrugator |
|---|---|---|---|---|---|---|
| Test | cation | Sizing- | Posi- | heater | Face Liner | Speed |
| No. | method | adhesive | tion | Temp. | Temp. | (m/min) |
| 397a | Liner only | C*iGlu ™ | 2 | 170° C. | 53° C. | 91 |
| | | 036A9 | | | | |
| 397b | Liner only | C*iGlu ™ | 2 | 170° C. | 52° C. | 137 |
| | | 036A9 | | | | |
| 397c | Liner only | C*iGlu ™ | 2 | 170° C. | 51° C. | 91 |
| | | 036A9 | | | | |
| 367 | Liner only | C*iGlu ™ | 2 | 150° C. | 49° C. | 244 |
| | | C*iGlu ™ | | | | |
| | | 036A12 | | | | |
| 372 | Liner only | C*iGlu ™ | 2 | 160° C. | 52° C. | 137 |
| | | 036A12 | | | | |
| 376 | Liner only | C*iGlu ™ | 2 | 170° C. | 51° C. | 91 |
| | | 036A12 | | | | |
| 388 | Liner only | C*iGlu ™ | 2 | 150° C. | 50° C. | 183 |
| | | 036A13 | | | | |
| 393 | Liner only | C*iGlu ™ | 2 | 160° C. | 55° C. | 137 |
| | | 036A13 | | | | |
| 394 | Liner only | C*iGlu ™ | 2 | 160° C. | 51° C. | 183 |
| | | 036A13 | | | | |
| 379a | Liner only | C*iGlu ™ | 2 | 150° C. | 46° C. | 91 |
| | | 036A17 | | | | |
| 379b | Liner only | C*iGlu ™ | 2 | 150° C. | 46° C. | 137 |
| | | 036A17 | | | | |
| 379c | Liner only | C*iGlu ™ | 2 | 150° C. | 45° C. | 183 |
| | | 036A17 | | | | |
| 384 | Liner only | C*iGlu ™ | 2 | 160° C. | 51° C. | 137 |
| | | 036A17 | | | | |
| 385 | Liner only | C*iGlu ™ | 2 | 170° C. | 49° C. | 137 |
| | | 036A17 | | | | |

According to Table 3, by continuously coating the sizing-adhesive on the paper and then applying the coated side to a pre-heater, for a given sizing-adhesive, the single facer liner temperature is very stable within a wide speed range. This temperature control gives corrugated board manufacturers another means to avoid paper damage due to overheating and helps them to increase the quality of the corrugated board they manufacture. Surprisingly, the temperature of the single face liner is below temperature range suggested in the IPST study mentioned above.

An additional advantage of heating the paper as shown in FIG. 3, is further explained by FIG. 4. Without wishing to be bound by theory, it is believed that as the paper is coated with the sizing-adhesive is passed over the hot pre-heater surface, a layer of water vapor is generated. This water vapor creates a pressurized zone causing the sizing adhesive to penetrate into the paper giving enhancing the sizing effect to the paper while reinforcing bond strength.

This reinforcing effect is illustrated by measuring the corrugated paperboard made with the sizing adhesive applied. Table 4 provides additional evidence that very good bonding using sizing-adhesive occurs. All tests were run with the wrap 2 as shown in the FIG. 3.

TABLE 4

| | | Single | PAT | ECT | P1 Pre- | Corrugator |
|---|---|---|---|---|---|---|
| Test | Sizing- | Face Liner | (N/m) | Improve- | heater | Speed (m/ |
| No. | adhesive | Temp. | SF Side | ment | Temp. | minute) |
| 368 | C*iGlu ™ | 52° C. | 511 | 8% | 150° C. | 183 |
| | 036A12 | | | | | |
| 371 | C*iGlu ™ | 52° C. | 580 | 9% | 160° C. | 137 |
| | 036A12 | | | | | |
| 378 | C*iGlu ™ | 57° C. | 670 | 10% | 170° C. | 183 |
| | 036A12 | | | | | |

Testing was done at various speeds and pre-heater temperature. The temperature of the single face liner was maintained within a temperature range of 5° C. This temperature range corresponds to the range of temperature for bonding discussed in FIG. 2. Of importance is that the speed of the corrugator was varied and the temperature of the pre-heater was also varied. This illustrates the robust nature of the process as it resists dramatic swings in paper temperature resulting from pre-heater temperature changes. PAT values of over 400 N/m are considered adequate to produce good quality corrugated paperboard. As seen in Table 4, this value is exceeded in all these test condition with different sizing-adhesives.

All test results in Table 4 were created by testing corrugated paperboard generated using the same 28 lb/msf paper for the single face, double face and medium on a double face corrugated paperboard construction. All of the samples were compared against a reference generated by bonding the papers using B flute corrugating rolls and a standard Stein Hall adhesive, Cargill's 03627, on the flute tips alone. In order to estimate the effect of increasing the ECT by 10%, the ECT needs to be related to the increase in compressive strength of the papers used. We can rearrange the Whitsitt equation (2) above to:

ECT−12=0.8(RCT_{SFL}+RCT_{DBL}+σRCT_{M}) (7)

By using the same papers on the single face, double backer and medium, RCT_{SFL}=RCT_{DBL}=RCT_{M}=RCT₂₈ where RCT₂₈ is equal the RCT of the 28 lbs/msf paper. A board was produced with B fluted medium using corrugators rolls with a take-up factor σ˜1.3
Incorporating these values the Whitsit equation becomes:

ECT−12=0.8(3.3RCT₂₈) (8)

The ECT of reference board was measured as 32 lbs/in and substituting this value into equation (7) above the RCT₂₈=7.6 lbs/in. If ECT increases by 10% by treating the single face liner than:

1.1ECT−12=0.8(RCT_{SA}+RCT₂₈+1.3RCT₂₈) (9)

where RCT_{SA} is the RCT in lbs/in of the single face liner after treatment with the sizing adhesive.
Equation (9) can be re-arranged to:

1.1ECT−12=0.8(xRCT₂₈+RCT₂₈+1.3RCT₂₈)=0.8(xRCT₂₈+2.3RCT₂₈) (10)

where x is the amount of increase in strength due to the treatment of the single face liner with the sizing-adhesive. Subtracting equation (8) from (10):

1.1ECT−12−ECT+12=0.8(xRCT₂₈+2.3RCT₂₈)−0.8(3.3RCT₂₈ (11)

becomes

0.1ECT=0.8(xRCT₂₈+2.3RCT₂₈−3.3RCT₂₈) and re-arranging becomes: (12)

ECT=8*(x−1)RCT₂₈ (13)

Equation (8) says ECT−12=0.8(3.3RCT₂₈)=2.6RCT₂₈ Re-arranging becomes:

ECT=2.6RCT₂₈+12 (14)

Setting equation (14) equal to (13):

2.6RCT₂₈+12=8*(x−1)RCT₂₈ (15)

and by re-arrangement

$$x = \frac{12 / {RCT}_{28} + 10.6}{8} \qquad ( 16 )$$

From above it has been shown that RCT₂₈=7.6 lbs/in and substituting this number in equation (16) for RCT₂₈ gives x=1.5

RCT_{SA}=1.5RCT₂₈

This calculation than says that a 50% RCT increase in the liner used in place of one of the 28 lb/msf liner is needed to achieve a 10% increase in ECT. Based on the linear relationship of the basis weight discussed above in Equation (5)

$${P}_{SA} = {P}_{28} \frac{{RCT}_{SA}}{{RCT}_{28}} = {P}_{28} \frac{1.5 {RCT}_{28}}{{RCT}_{28}} = 1.5 {P}_{28}$$

and the paper basis weight required to raise the ECT by 10% is 50%. Therefore, the predicted increase in basis weight to increase the ECT by 10% is 1.5×28 lbs/msf or 42 lbs/msf and by the coating of the sizing-adhesive on only the single liner paper, 14 lbs/msf may be eliminate from the corrugated paperboard.

1. A process for making a corrugated board comprising the steps of:
A. providing a sizing-adhesive, at least one sheet of a corrugating medium, and at least one liner sheet, wherein the sizing-adhesive comprises a at least an ungelled starch;
B. applying the sizing-adhesive as a continuous film to at least one surface of the corrugating medium, liner sheet, or flute tips or combinations thereof, to yield a sizing-adhesive surface;
C. heating the sizing-adhesive surface to a temperature sufficient to partially or completely gel said ungelled starch; and
D. bonding the sizing-adhesive surface to a second corrugating medium, liner sheet or flute tip to obtain a corrugated board.

2. The process according to claim 1, wherein the amount of ungelled starch is greater than 10% and less than 80% of the sizing-adhesive.

3. The process according to claim 1, wherein the sizing-adhesive surface is heated by direct contact with a hot surface.

4. The process according to claim 3, wherein the sizing-adhesive is heated up to 100° C.

5. The process according to claim 3, wherein the temperature of the sizing-adhesive surface is less than 80° C. before bonding to a second surface.

6. The process according to claim 1, further comprising a paper web speed of less than 1000 meters/min.

7. The process according to claim 3, wherein water from the sizing-adhesive is vaporized between a heating surface and the sizing-adhesive surface.

8. The process according to claim 1, further comprising drying the corrugated board.

9. The sizing-adhesive according to claim 1, further comprising one or more additives selected from the group consisting of: fillers, bonding additives, humectants, tackifiers, water resistance resins, thickeners, antifoam agents, preservatives, anti-microbials or combinations thereof.

10. The sizing-adhesive according to claim 9, further comprising between 0.1 and 30% by weight of the one or more additives on a dry weight basis.

11. The sizing-adhesive according to claim 1, wherein the sizing-adhesive has a pH of 7 or above.

12. The process according to claim 1, wherein the at least one liner sheet is coated with the sizing-adhesive in an amount of up to 20 g/m² on a dry weight basis.

13. (canceled)

14. The process according to claim 1, wherein the weight of the sheets is reduced by up to 15 g/m², preferably by between 1 to 15 g/m², more preferably by between 2 to 8 g/m², per gram of sizing-adhesive applied to the sheet.

15. The process according to claim 1, wherein the strength of the corrugated board is improved by an increase in ECT of at least 1% higher, preferably at least 5% higher, compared to a corrugated board made by applying a Stein Hall adhesive to the flute tips.

16. The process according to claim 14, wherein the amount of ungelled starch is greater than 10% and less than 80% of the sizing-adhesive.

17. The process according to claim 14, wherein the sizing-adhesive surface is heated by direct contact with a hot surface.

18. The process according to claim 17, wherein the sizing-adhesive is heated up to 100° C.

19. The process according to claim 17, wherein the temperature of the sizing-adhesive surface is less then 80° C. before bonding to a second surface.

20. The process according to claim 14, further comprising a paper web speed of less than 1000 meters/min.

21. The process according to claim 17, wherein water from the sizing-adhesive is vaporized between a heating surface and the sizing-adhesive surface.

22. The process according to claim 14, further comprising drying the corrugated board.

23. The sizing adhesive according to claim 14, further comprising one or more additives selected from the group consisting of fillers, bonding additives, humectants, tackifiers, water resistance resins, thickeners, antifoam agents, preservatives, anti-microbials or combinations thereof.

24. The sizing adhesive according to claim 23, further comprising between 0.1 and 30% by weight of the one or more additives on a dry weight basis.

25. The sizing-adhesive according to claim 14, wherein the sizing adhesive has a pH of 7 or above.

26. The process according to claim 14, wherein the at least one liner sheet is coated with the sizing-adhesive in an amount of up to 20 g/m² on a dry weight basis.

27. The process according to claim 15, wherein the amount of ungelled starch is greater than 10% and less than 80% of the sizing-adhesive.

28. The process according to claim 15, wherein the sizing-adhesive surface is heated by direct contact with a hot surface.

29. The process according to claim 28, wherein the sizing-adhesive is heated up to 100° C.

30. The process according to claim 28, wherein the temperature of the sizing-adhesive surface is less than 80° C. before bonding to a second surface.

31. The process according to claim 15, further comprising a paper web speed of less than 1000 meters/min.

32. The process according to claim 28, wherein water from the sizing-adhesive is vaporized between a heating surface and the sizing-adhesive surface.

33. The process according to claim 15, further comprising drying the corrugated board.
